(19) United States
(12) Patent Application Publication
(10) Pub. No.: US 2013/0294708 A1
(43) Pub. Date: Nov. 7, 2013

(54) OBJECT SEPARATING APPARATUS, IMAGE RESTORATION APPARATUS, OBJECT SEPARATING METHOD AND IMAGE RESTORATION METHOD

(71) Applicants: Tomohide Maeda, Fukuoka (JP); Kenji Tabei, Fukuoka (JP)

(72) Inventors: Tomohide Maeda, Fukuoka (JP); Kenji Tabei, Fukuoka (JP)

(73) Assignee: PANASONIC CORPORATION, Osaka (JP)

(21) Appl. No.: 13/997,284

(22) PCT Filed: Jan. 20, 2012
(86) PCT No.: PCT/JP2012/000346

§ 371 Date: Jun. 24, 2013

(30) Foreign Application Priority Data
Jan. 25, 2011 (JP) 2011-012964

(51) Int. Cl. G06T 5/00

(52) U.S. Cl. CPC G06T 5/003
USPC 382/275

(57) ABSTRACT

An apparatus that can obtain a clear image by correcting blurs of respective object images even in a case where a plurality of objects with different blurs exists within an image. Local PSF estimating section estimates a PSF for each small region. PSF form identifying section identifies forms of the estimated PSFs of the small regions and groups local estimated PSFs such that small regions having the PSF forms with high similarity belong to the same group. Small region integrating section integrates adjacent small regions that are grouped in the same group. Due to this, object images blurring in a similar way can be accurately separated. As a result of this, a perspective separation of the objects and a separation of moving objects become possible from just one input image without using a plurality of cameras or additional devices (a distance sensor, etc.).

### TECHNICAL FIELD

The present invention relates to an image restoration apparatus that corrects image degradations such as a blur in an image generated for example in a process of taking the image (blur caused by defocusing or camera shake) and thereby restores a clear image, and an object separating apparatus that is suitably used in the image restoration apparatus.

### BACKGROUND ART

Conventionally, techniques using a PSF (Point Spread Function) have been known as the technique for restoring (correcting) image degradations. This technique is a technique that utilizes the fact that a degraded image can be expressed by convoluting the PSF in an original clear image, and can restore the original clear image by performing deconvolution operation of the PSF on the degraded image.

The image restoration technique using the PSF can be roughly categorized into a Non-blind method and a Blind method.

The Non-blind method restores the original image from the degraded image assuming that the PSF is known. In this method, for example, an inverse filter or a Wiener filter is used.

The Blind method performs the restoration by the Non-blind method after having estimated an unknown PSF from the degraded image. The Blind method is described for example in NPLs 1 to 4.

Incidentally, the conventional image restoration technique using the PSF generally is on a premise that identical blurs are occurring in within the image; thus, it has a defect that an accuracy of the image restoration is decreased in a case where a plurality of objects with different blurs exists within the image.

In view of the foregoing, an image correcting apparatus that performs a blur correction is described in PTL 1. The technique disclosed in PTL 1 will briefly be explained. The image correcting apparatus in PTL 1 is configured to restore the blur in the image by the following procedure.

1. One small region in an input image is taken as a reference, and this is assumed as a reference region.

2. A PSF estimation is performed in the reference region.

3. The PSF estimation is performed in a region which the reference region has been expanded.

4. A determination is made as to whether the respective estimated PSFs before and after the expansion in the above 3. If they are similar, the procedure returns to the above 3 with the expanded region of the above 3 as the reference region. If they are not similar, the procedure returns to the above 1 by determining the reference region before the expansion as one adaptive region.

5. An interpolation is performed on the PSFs estimated by the above processes of 1 to 4 for each of the adaptive regions. If there are similar ones among the PSFs of the respective adaptive regions, the interpolation process is performed using those PSFs, and thereby PSFs of pixels at outer side of a center of the adaptive regions are obtained.

6. Blur in the image is restored by the Non-blind method based on the calculated PSFs.

### CITATION LIST

### Patent Literature

[PTL 1]

International Publication No. 2010/098054

### Non Patent Literature

[NPL 1]

Fergus, et al., “Removing camera shake from a single photograph”, SIGGRAPH 2006 Papers, ACM, 2006, pp.787-794.

[NPL 2]

Shan, et al., “High-quality motion deblurring from a single image”, SIGGRAPH 2008 Papers, ACM, 2008, Article No. 73.

[NPL 3]

Cho, et al., “Fast motion deblurring”, SIGGRAPH Asia 2009 Papers, ACM, 2009, Article No. 145.

[NPL 4]

Cai, et al., “Blind motion deblurring from a single image using sparse approximation”, 2009 IEEE Conference on Computer Vision and Pattern Recognition, CVPR, 2009, pp.104-111.

### SUMMARY OF INVENTION

### Technical Problem

Incidentally, in the technique disclosed in PTL 1, the PSFs are estimated by gradually widening the reference region, so that it is probably defective in performing the PSF estimation that overlooks an entirety of the image. Further, depending on how the reference region is set, it is considered that a calculation amount for the PSF estimation is unnecessarily increased, and the estimation accuracy of the PSF is decreased if the calculation amount is suppressed.

That is, there is a risk that, with a limited hardware resource, if a high-speed image restoration is to be performed, the accuracy of the image restoration is decreased.

The present invention is made by taking these points into consideration, and aims to provide an image restoration apparatus and an image restoration method that can obtain a clear image by correcting the blurs of the respective object images with relatively small calculation amount even in the case where the plurality of objects with different blurs exists within the image, and an object separating apparatus and an object separating method that are suitably used therein.

### Solution to Problem

One embodiment of an object separating apparatus of the present invention is provided with a small region dividing section that divides an input image into a plurality of small region images; a local PSF estimating section that estimates PSFs of the small region images; a PSF form identifying section that identifies forms of the estimated PSFs and groups the small region images such that small region images having the PSF forms with high similarity belong to the same group; and a small region integrating section that obtains object images separated into respective groups by integrating, for each of the groups, the small region images that are grouped in the same group and are adjacent.

One embodiment of an image restoration apparatus of the present invention is provided with the above object separating apparatus; an object PSF estimating section that estimates, by using respective object images separated by the object separating apparatus, PSFs of the respective object images; and an image restoring section that obtains a restored image in which degradations in the object images are corrected by using the PSFs estimated by the object PSF estimating section and the object images.

### Advantageous Effects of Invention

According to the present invention, the image restoration apparatus and the image restoration method that can obtain a clear image by correcting the blurrs of the respective object images with relatively small calculation amount even in the case where the plurality of objects with different blurrs exists within the image, and the object separating apparatus and the object separating method that are suitably used therein can be realized. Further, according to the object separating apparatus and method of the present invention, a perspective separation of the objects and a separation of moving objects become possible from just one input image without using a plurality of cameras or additional devices (a distance sensor, etc.).

### BRIEF DESCRIPTION OF DRAWINGS

[FIG. 1]

FIG. 1 is a block diagram showing a configuration of an object separating apparatus of an embodiment;

[FIG. 2]

FIG. 2 is a diagram showing how an image is divided;

[FIG. 3]

FIG. 3 includes diagrams used for explaining a local PSF estimation performed by a local PSF estimating section; FIG. 3A is a flow chart showing a process procedure of the local PSF estimation, and FIG. 3B is a diagram showing an example of a PSF estimation result (forms of estimated PSFs);

[FIG. 4]

FIG. 4 includes diagrams used for explaining the PSF; FIG. 4A is a diagram showing an output image obtained by inputting an ideal point source image in a PSF, and FIG. 4B is a diagram showing an output image obtained by inputting an actual image to the PSF;

[FIG. 5]

FIG. 5 includes diagrams used for explaining a PSF form; FIG. 5A is a diagram showing an example of the PSF form of a blurred image, and FIG. 5B is a diagram showing an example of the PSF form of an object moving in a horizontal direction;

[FIG. 6]

FIG. 6 is a diagram showing an example of object images that have been separated by the object separating apparatus of the embodiment;

[FIG. 7]

FIG. 7 is a block diagram showing a configuration of an object separating apparatus of an embodiment;

[FIG. 8]

FIG. 8 shows small regions overlapping one another;

[FIG. 9]

FIG. 9 is a block diagram showing a configuration of an object separating apparatus of an embodiment;

[FIG. 10]

FIG. 10 is a diagram showing an image of an interpolation process;

[FIG. 11]

FIG. 11 is a block diagram showing a configuration of an object separating apparatus of an embodiment;

[FIG. 12]

FIG. 12 is a block diagram showing a configuration of an image restoration apparatus of an embodiment;

[FIG. 13]

FIG. 13 is a block diagram showing a configuration of an image restoration apparatus of an embodiment; and

[FIG. 14]

FIG. 14 is a block diagram showing a configuration of an image restoration apparatus of an embodiment.

### DESCRIPTION OF EMBODIMENTS

Hereinbelow, embodiments of the present invention will be explained with reference to the drawings.

(1) Configuration I of an Object Separating Apparatus

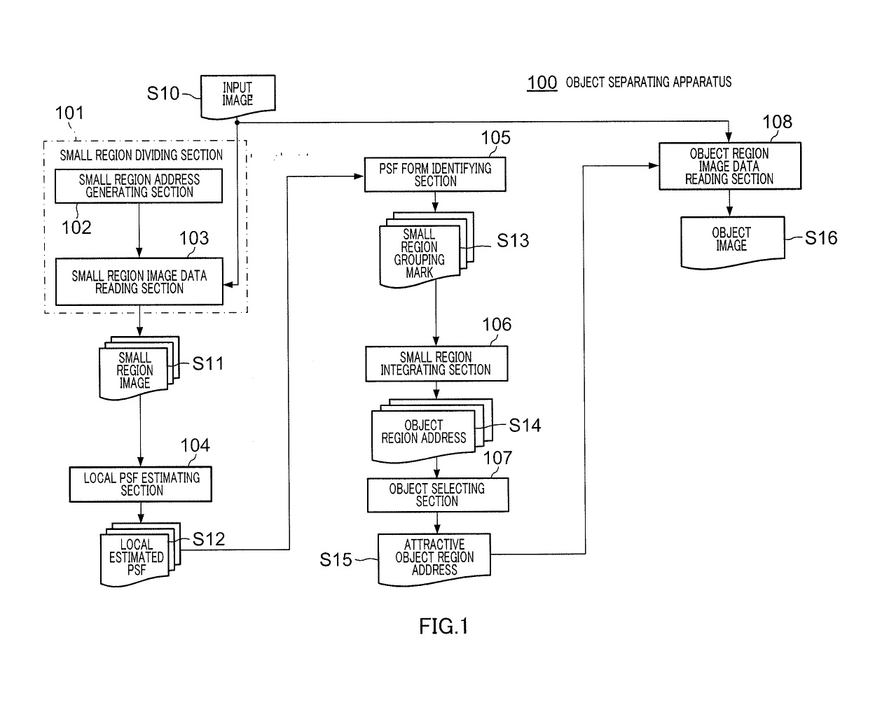

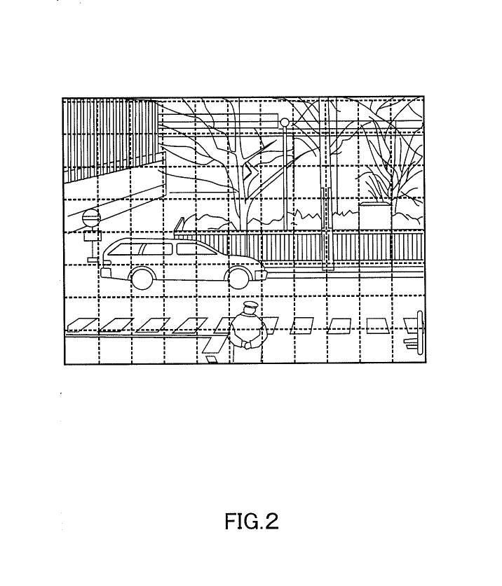

A configuration of the object separating apparatus of the present embodiment is shown in. FIG. 1. Object separating apparatus 100 inputs input image S10 to small region dividing section 101. Small region dividing section 101 includes small region address generating section 102 and small region image data reading section 103. Small region address generating section 102 generates addresses of respective small regions and successively outputs the same. Small region image data reading section 103 includes a memory storing input image S10, and by reading out an image based on the addresses generated in small region address generating section 102, divides one piece of input image S10 into a plurality of small region images S11 and outputs the same. How the image is divided by small region dividing section 101 is shown in FIG. 2. Each of regions partitioned by dotted lines within the drawing is the divided small region.

Small region images S11 obtained by small region dividing section 101 are input to local PSF (Point Spread Function) estimating section 104. Local PSF estimating section 104 estimates a PSF for each small region image.

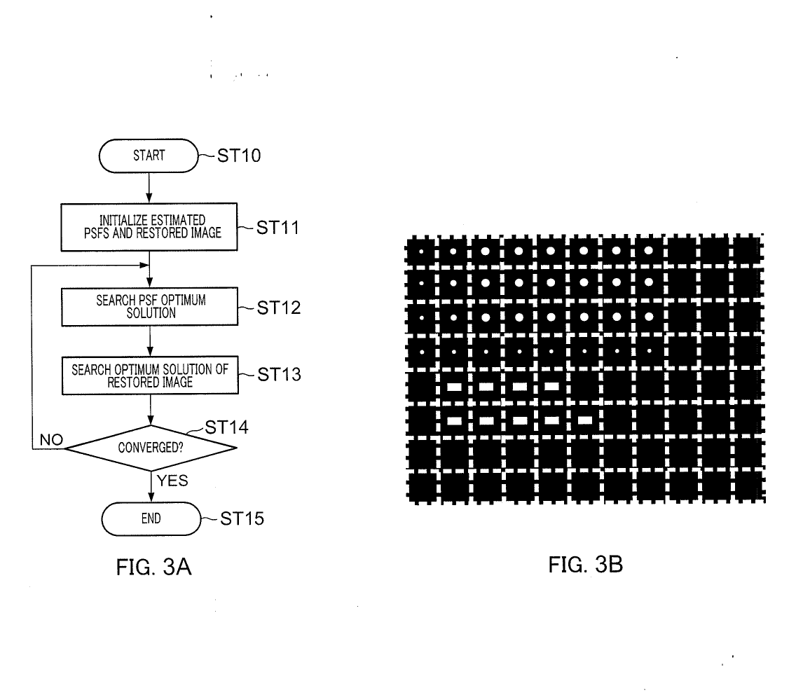

FIG. 3 includes diagrams used for explaining a local PSF estimation performed by local PSF estimating section 104. FIG. 3A shows a process procedure of the local PSF estimation. As shown in FIG. 3A, when small region image S11 is input, local PSF estimating section 104 starts a process at step ST10, and in step ST11, initializes a PSF to be estimated and a restored image. In step ST12, an optimum solution of the PSF is searched, and in step ST13, an optimum solution of the restored image is searched. In a successive step ST14, a determination is made on whether the optimum solutions have converged or not, and in a case of having converged (step ST14: YES), the local PSF estimation process is ended in step ST15. In a case of not having converged (step ST14: NO), the process returns to step ST12, and the processes of steps ST12-ST13-ST14 are repeated until the optimum solutions converge. Local PSF estimating section 104 performs the process of FIG. 3A to each of the small region images.

FIG. 3B shows an example of a PSF estimation result (forms of estimated PSFs). Circles within the drawing show that the larger they are, the greater the blur therein. Bars in linear shapes show movements. Specifically, a horizontal bar shows that an object within that region has moved horizontally, and a vertical bar shows that an object within that region has moved vertically.

Here, a brief explanation of a PSF and the PSF form will be given.

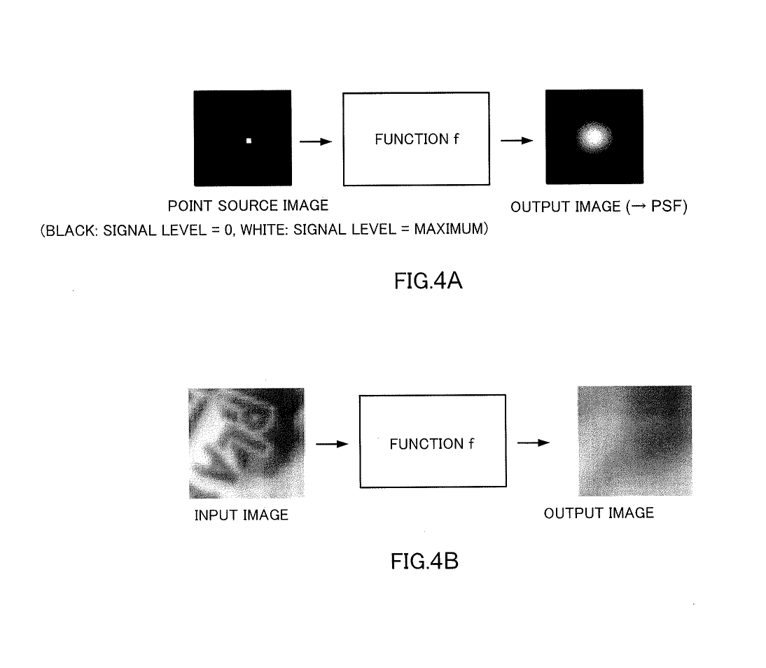

Firstly, the PSF will be explained using FIG. 4. FIG. 4A shows an output image obtained by inputting an ideal point source image (point image) to the PSF (function f). The output image is used with function f defining the PSF. FIG. 4B shows an output image obtained by inputting an actual image to the PSF (function f). A blurring output image can be generated through function f by operating a convolution of an image signal of the PSF of function f and an input image signal.

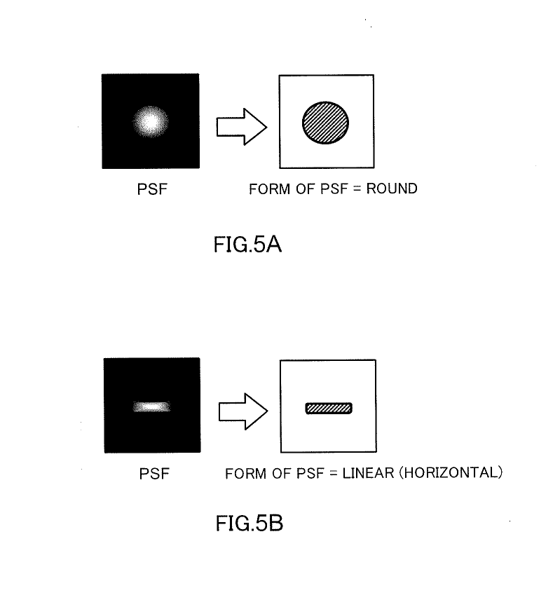

Next, the PSF form will be explained using FIG. 5. The PSF form is a figure formed on an image plane by a group of pixels when only those pixels with a signal level that is at a threshold or more are extracted from each of the signals in a PSF image. FIG. 5A shows an example of the PSF form of a blurred image, and FIG. 5B shows an example of the PSF form of an object moving in the horizontal direction.

Returning to FIG. 1, the explanation of the configuration of object separating apparatus 100 will be resumed. PSF form identifying section 105 identifies forms of the estimated PSFs of the small regions and groups the small regions such that small regions having the PSF forms with high similarity belong to the same group. Based on a grouping result, PSF form identifying section 105 links a grouping mark to information of each small region, and outputs the same as small region grouping mark S13.

Small region integrating section 106 integrates adjacent small regions that are grouped in the same group. Further, small region integrating section 106 determines that the small regions grouped in the same group and integrated are the same object image and outputs integrated object region address S14. That is, small region integrating section 106 outputs addresses of the regions that have been determined as being the same object as object region address S14, in a manner that those are the address of the same object.

Object selecting section 107 selects an object that is to be subjected to a restoration process (which may also be termed a correction process), and outputs an address of that region forming the object as attractive object region address S15. Note that, the selected object may for example be an object designated by a user. Further, the selected object may be one that is orderly selected in a predetermined order.

Object region image data reading section 108 includes a memory storing input image S10, and outputs object image S16 by reading out the image based on the attractive object region address.

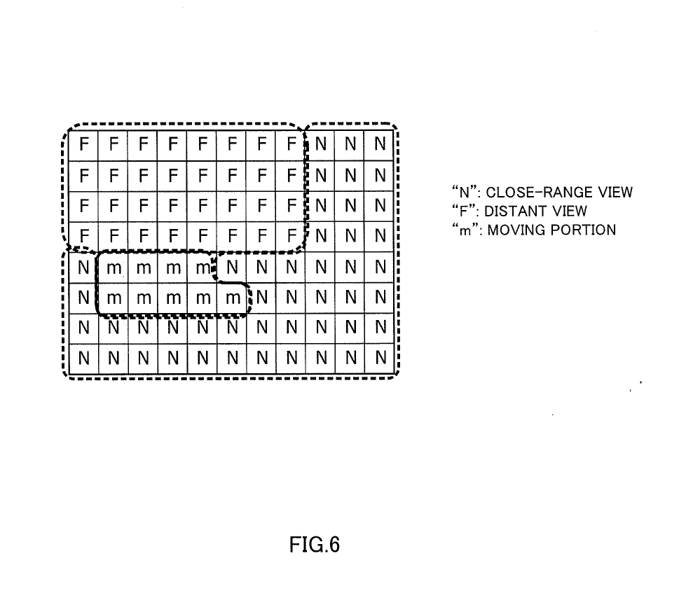

FIG. 6 shows an example of object images that have been separated by object separating apparatus 100. The PSF forms of the small regions in close-range view N are similar, the PSF forms of the small regions in distant view F are similar, and the PSF forms of the small regions in moving portion m are similar. On the other hand, the PSF forms differ greatly among close-range view N, distant view F, and moving portion m. As a result of this, a grouping that divides groups with dotted lines in the drawing as borders is performed by PSF form identifying section 105 and small region integrating section 106, and the small regions within the same group are integrated. According to this, the objects can be separated accurately based on the difference in how they are blurred.

As mentioned above, according to object separating apparatus 100 of the present embodiment, by including small region dividing section 101 that divides input image S10 into a plurality of small region images S11; local PSF estimating section 104 that estimates the PSFs of small regions; PSF form identifying section 105 that identifies forms of local estimated PSFs S12 of the small regions estimated and groups local estimated PSFs S12 such that small regions having the PSF forms with high similarity belong to the same group; and small region integrating section 106 that integrates the adjacent small regions that are grouped in the same group, object images being blurred in a similar way are accurately separated. As a result of this, a perspective separation of the objects and a separation of moving objects become possible from just one input image without using a plurality of cameras or additional devices (a distance sensor, etc.). Further, object separating apparatus 100 can perform such separation with relatively less amount of operation.

(2) Configuration II of the Object Separating Apparatus

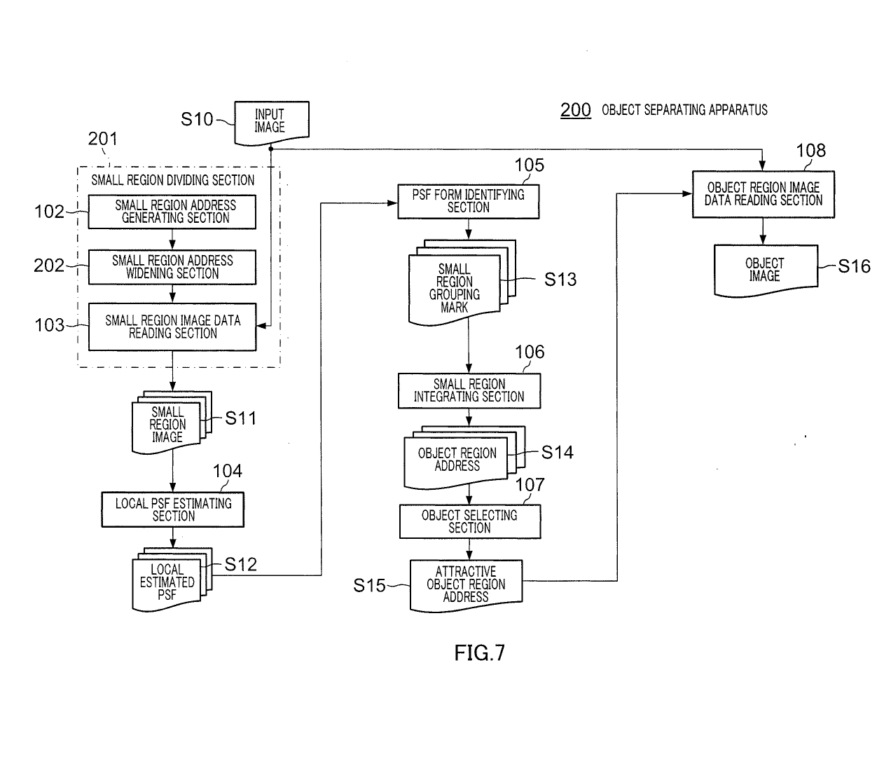

In FIG. 7 having the same reference signs for components corresponding to those of FIG. 1, another example of a configuration of the object separating apparatus is shown. Object separating apparatus 200 of FIG. 7 differs in its configuration of small region dividing section 201 compared to object separating apparatus 100 of FIG. 1.

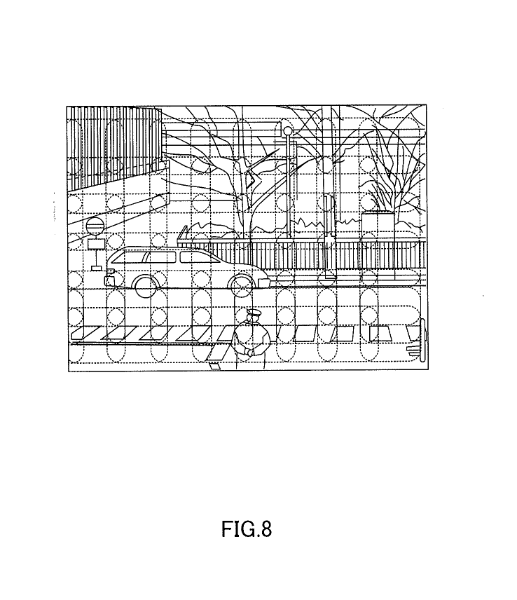

Small region dividing section 201 of object separating apparatus 200 includes small region address widening section 202. Small region address widening section 202 generates an address for widening the small region by using the addresses from small region address generating section 102. Specifically, as shown in FIG. 8, small regions overlapping one another are formed. By configuring as above, since a number of samples in the small region increases more than of a simple grid division, a local PSF estimation performance in local PSF estimating section 104 is improved. As a result of this, the oncoming final separation of the objects can also be performed more accurately.

(3) Configuration III of the Object Separating Apparatus

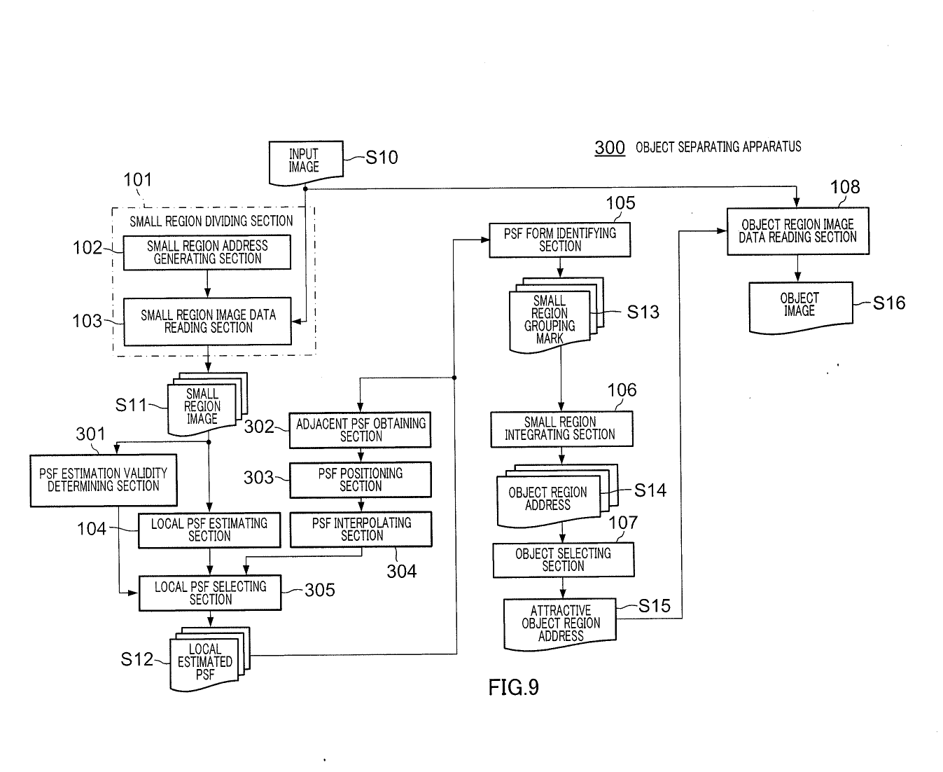

In FIG. 9 having the same reference signs for components corresponding to those of FIG. 1, another example of a configuration of the object separating apparatus is shown. Object separating apparatus 300 obtains a PSF of a small region which seems to have a low reliability in its PSF estimation by positioning a PSF estimated in an adjacent small region and interpolating the same.

PSF estimation validity determining section 301 determines whether each of small region images S11 is a small region in which the reliability of the PSF estimation is likely to be lowered or not. PSF estimation validity determining section 301 determines validity of the PSF estimation based on (i) a number of saturated pixels, or (ii) intensity gradient and the like as the index for the reliability of the PSF. Specifically, PSF estimation validity determining section 301 determines that a small region is flat and has no character (the reliability of the PSF estimation being low) in cases of the number of saturated pixels being at or more than a threshold, or the intensity gradient being substantially zero, and determines not to use the PSF estimation estimated using this small region.

Adjacent PSF obtaining section 302 obtains local estimated PSF S12 of the adjacent small region for each small region. PSF positioning section 303 positions the centers of gravity of local estimated PSFs S12 of the adjacent small region. PSF interpolating section 304 uses the PSFs which have been positioned and for example calculates an average thereof, thereby obtaining the PSF of the small region that is to be subjected to interpolation.

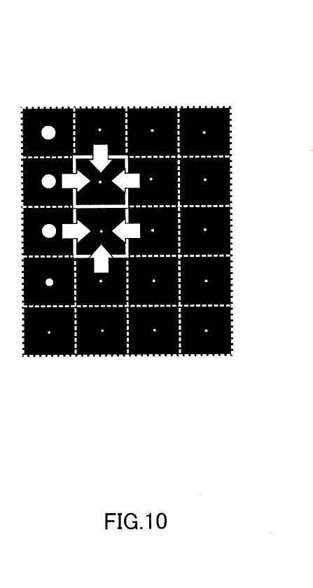

FIG. 10 shows an image of the processes by adjacent PSF obtaining section 302, PSF positioning section 303, and PSF interpolating section 304. The small region in a solid line in the drawing is the small region to be subjected to the interpolation. As shown with arrows in the drawing, a PSF of a small region adjacent to the small region to be subjected to the interpolation is obtained, and positioning is performed. Then, by using the positioned PSF, the PSF of the small region to be subjected to the interpolation is calculated.

Local PSF selecting section 305 simply outputs the PSF estimated by local PSF estimating section 104 for the small region (that is, the small region that is not flat) that had been determined to perform the PSF estimation by PSF estimation validity determining section 301. Contrary to this, local PSF selecting section 305 outputs the PSF calculated by PSF interpolating section 304 instead of the PSF estimated by local PSF estimating section 104 for the small region (that is, the small region that is flat) that had been determined not to perform the PSF estimation by PSF estimation validity determining section 301.

As in the above, object separating apparatus 300 selects whether to estimate the PSF of the small region image by using this small region image or by using the PSF calculated from the surrounding small region images, based on the flatness of the small region image. Due to this, an occurrence of a loss in the object region extracted by integrating the small regions can be prevented.

(4) Configuration IV of the Object Separating Apparatus

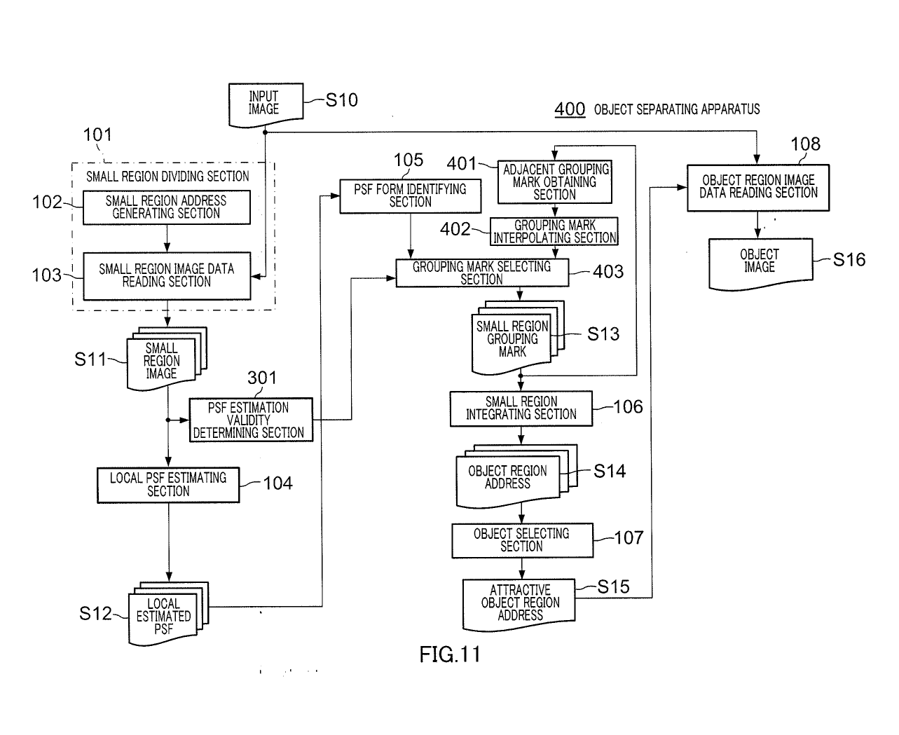

In FIG. 11 having the same reference signs for components corresponding to those of FIG. 1 and FIG. 9, another example of a configuration of the object separating apparatus is shown. For a small region whose reliability of the PSF estimation seems low, object separating apparatus 400 is configured to decide the group of the small region based on a grouping result of the adjacent small region.

Adjacent grouping mark obtaining section 401 obtains the grouping mark of the adjacent small region for each of the small regions.

Grouping mark interpolating section 402 obtains the grouping mark of the small region that is to be subjected to interpolation by using the grouping mark of the adjacent small region. As to how the interpolation is to be performed, for example, the grouping mark that is largest in its number among the grouping marks of adjacent small regions may be selected as an interpolating grouping mark.

Grouping mark selecting section 403 simply outputs the grouping mark obtained by PSF form identifying section 105 for the small region (that is, the small region with high reliability of the PSF) that had been determined to perform the PSF estimation by PSF estimation validity determining section 301. Contrary to this, grouping mark selecting section 403 outputs the grouping mark obtained by grouping mark interpolating section 402 instead of the grouping mark acquired by PSF form identifying section 105 for the small region (that is, the small region with low reliability of PSF) that had been determined not to perform the PSF estimation by PSF estimation validity determining section 301.

Accordingly, object separating apparatus 400 selects whether to perform the grouping of the small region by using a PSF estimation result of this small region or by using a grouping result of surrounding small regions, based on the reliability of the PSF of the small region image. Due to this, similar to object separating apparatus 300, the occurrence of the loss in the object region extracted by integrating the small regions can be prevented.

(5) Configuration I of an Image Restoration Apparatus

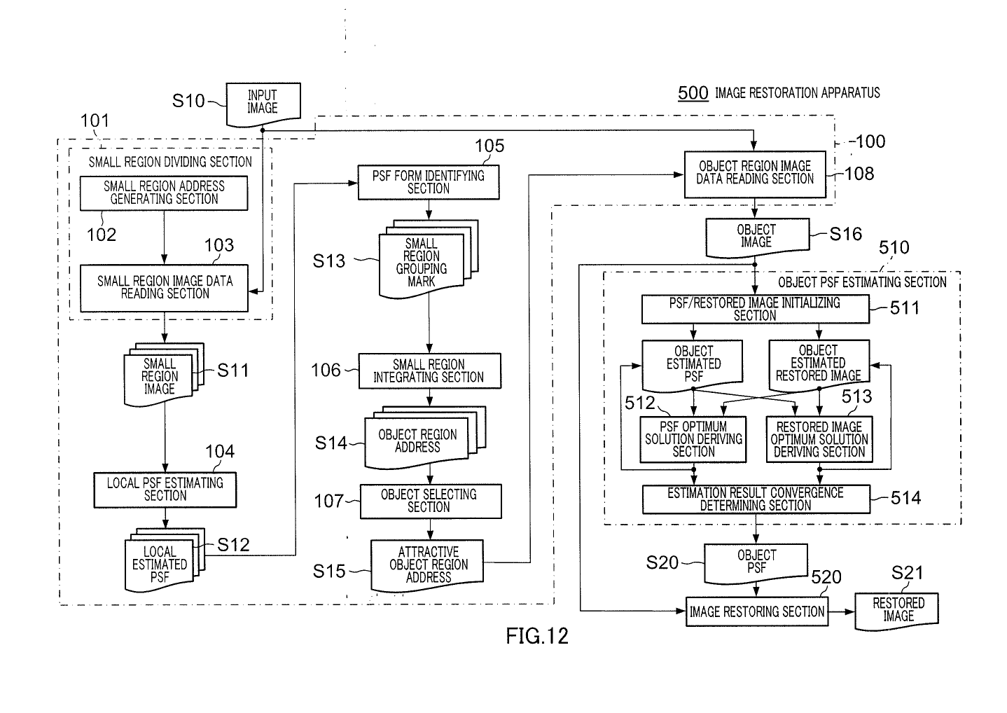

FIG. 12 shows a configuration of an image restoration apparatus. Image restoration apparatus 500 includes object separating apparatus 100 (FIG. 1), object PSF estimating section 510, and image restoring section 520. Note that, instead of object separating apparatus 100 (FIG. 1), object separating apparatus 200 (FIG. 7), 300 (FIG. 9), or 400 (FIG. 11) may be used.

As described above, object separating apparatuses 100, 200, 300, and 400 output object images S16 configured by accumulating (integrating) the small regions with similar blur. Thus, object images S16 configured by the small regions having the same degree of blur being accumulated are input to object PSF estimating section 510 from object separating apparatus 100.

Object PSF estimating section 510 calculates the PSF of the object by using a PSF estimating algorithm. As this PSF estimating algorithm, conventional ones may be used. Here, a summary thereof will briefly be explained.

PSF estimating algorithm uses a statistic property that can generally be materialized for a natural image (with no blur) and a PSF, and assumes ones with the most probability as an estimated image and an estimated PSF respectively from among combinations of an original image (unknown) and a PSF (unknown) that would generate the input image (observed data) with blur.

Firstly, an assumption is made as to a clear image (hereinafter L), as well as making an assumption of a PSF (hereinafter K). Here, the clear image is expressed as prior distribution p(L), and this is frequently assumed as “an intensity gradient distribution of L complies with Gaussian (or one similar thereto)”. Further, the PSF is expressed as prior distribution p(K), and this is frequently assumed as “a factor of K is non-negative, and it becomes a sparse distribution”.

Object PSF estimating section 510 performs a process according to the below procedure under the above assumptions.

Step 1: Initial values of L and K are set. It is typical to respectively set an input image (hereinafter B) as the initial value of L, and a PSF of a delta kernel (a PSF that assumes a value of 1 only at the center thereof, and a value of 0 for the remainders) or a simple shape (horizontal or vertical line) as the initial value of K.

Step 2: In assuming L as a fixed value and K as unknown, an equation “B=L×N” is solved for K by the MAP (Maximum A Posteriori) method.

L and K that maximize posterior distribution p (L, K|B) are calculated by a stochastic method using p(L), p(K), and p (B, L|K).

Step 3: Assuming K that has been derived as a fixed value and L as unknown, the above equation is similarly solved for L.

Step 4: The above steps (2 to 3) are repeated until K and L that have been derived are respectively converged. The converged K is the estimated PSF.

In object PSF estimating section 510, PSF/restored image initializing section 511 obtains an object estimated PSF and an object estimated restored image by performing step 1. PSF optimum solution deriving section 512 performs step 2. Further, restored image optimum solution deriving section 513 performs step 3. Estimation result convergence determining section 514 performs step 4. According to the above, estimated object PSF S20 is output from estimation result convergence determining section 514.

Image restoring section 520 obtains restored image S21 by using object PSF S20 and object image S16. Specifically, image restoring section 520 obtains restored image S21 which is a clear image by performing a deconvolution operation of object PSF S20 to deteriorated object image S16.

According to the above, image restoration apparatus 500 includes object separating apparatus 100 (FIG. 1), 200 (FIG. 7), 300 (FIG. 9), or 400 (FIG. 11), and by this object separating apparatus 100, 200, 300, or 400, obtains restored image S21 by calculating object PSF S20 based on object image S16 formed by accumulating the small regions with similar way of blurring. Due to this, a clear image can be obtained by correcting the blurs of the respective objects even in the case where the plurality of objects with different degree of blurs exists within the image, and the object separating apparatus and the object separating Method that are suitably used therein.

(6) Configuration II of the Image Restoration Apparatus

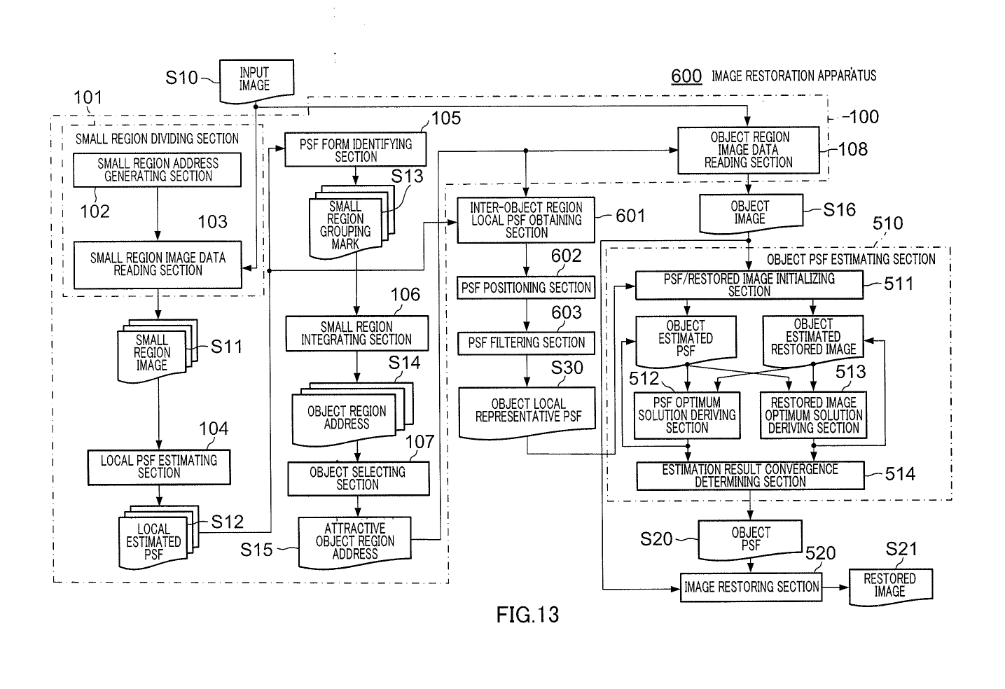

In FIG. 13 having the same reference signs for components corresponding to those of FIG. 12, another example of a configuration of the image restoration apparatus is shown. Image restoration apparatus 600 is configured to use the PSF that has already been calculated by object separating apparatus 100 (or 200, 300, 400) as the initial value of the PSF to be used in object PSF estimating section 510. Due to this, the process by object PSF estimating section 510 can be made faster, and the convergence can be stabilized.

In image restoration apparatus 600, inter-object region local PSF obtaining section 601 collects (obtains) the PSFs corresponding to the attractive object region address from among local estimated PSFs -S12 that have already been calculated by local PSF estimating section 104. PSF positioning section 602 positions the centers of gravity of the collected PSFs respectively. PSF filtering section 603 is for example an averaging filter, and obtains representative PSF (object local representative PSF) S30 of the attractive object.

This representative PSF S30 is input to PSF/restored image initializing section 511 of object PSF estimating section 510. PSF/restored image initializing section 511 sets the input representative PSF S30 as the initial value of the PSF.

By configuring as above, as aforementioned, compared to the case of setting the PSF of the delta kernel or the simple shape, a decrease in the calculation amount (number of iteration) before being converged is expected, and in addition a stabilization of the convergence is expected.

(7) Configuration III of the Image Restoration Apparatus

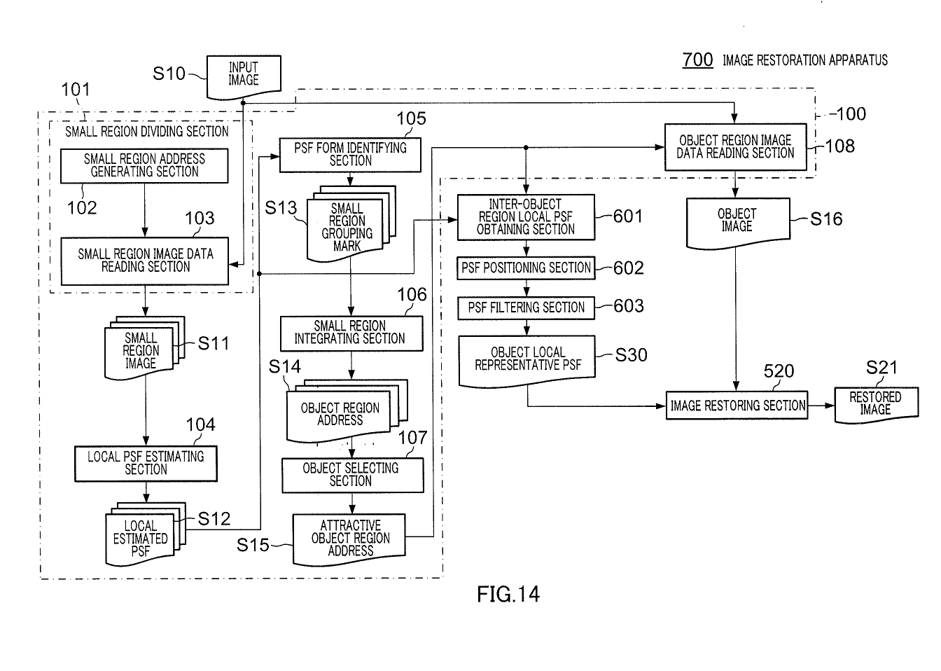

In FIG. 14 having the same reference signs for components corresponding to those of FIG. 13, another example of a configuration of the image restoration apparatus is shown. Compared to image restoration apparatus 600 of FIG. 13, image restoration apparatus 700 omits object PSF estimating section 510, and is configured to perform the image restoration process in image restoring section 520 by using object local representative PSF S30 output from PSF filtering section 603.

Due to this, compared to image restoration apparatus 600; in image restoration apparatus 700, since the PSF estimation by the MAP method is not performed, the accuracy of the PSF to be used in the image restoration will be lowered, however, since a circuit for performing the MAP method (object PSF estimating section 510) will not be necessary, the configuration can be simplified.

(8) Advantageous Effects of the Embodiments

As explained above, according to object separating apparatuses 100, 200, 300, and 400, object images S16 blurring in a similar way can be accurately separated. As a result of this, a perspective separation of the objects and a separation of moving objects become possible from just one input image without using a plurality of cameras or additional devices (a distance sensor, etc.). Further, object separating apparatuses 100, 200, 300, and 400 can perform such separation with relatively less amount of operation.

Further, image restoration apparatuses 500, 600, and 700 of the present embodiments include object separating apparatus 100, 200, 300, or 400, and obtain restored image S21 by calculating object PSFs S20 based on object images S16 formed by accurately collecting the small regions blurring in the similar way, thus can obtain a clear image by restoring the blurs of the respective objects even in the case where the plurality of objects with different types of blurs exists within the image.

Note that, object separating apparatuses 100, 200, 300, and 400 and image restoration apparatuses 500, 600, and 700 of the above embodiments can be configured by computers such as a personal computer and the like including a memory and a CPU. Further, the functions of the respective constitutional elements configuring the above apparatuses can be realized by the CPU reading out and executing computer programs stored in the memory.

The disclosure of Japanese Patent Application No. 2011-012964, filed on Jan. 25, 2011, including the specification, drawings and abstract, is incorporated herein by reference in its entirety.

### INDUSTRIAL APPLICABILITY

The present invention is suitably adapted to a case for example of correcting an image in which different types of blurs are occurring among objects.

### REFERENCE SIGNS LIST

100, 200, 300, 400 Object separating apparatus
101 Small region dividing section
102 Small region address generating section
103 Small region image data reading section
104 Local PSF estimating section
105 PSF form identifying section
106 Small region integrating section
107 Object selecting section
108 Object region image data reading section
202 Small region address widening section
301 PSF estimation validity determining section
302 Adjacent PSF obtaining section
303 PSF positioning section
304 PSF interpolating section
305 Local PSF selecting section
401 Adjacent grouping mark obtaining section
402 Grouping mark interpolating section
403 Grouping mark selecting section
500, 600, 700 Image restoration apparatus
510 Object PSF estimating section
511 PSF/restored image initializing section
512 PSF optimum solution deriving section
513 Restored image optimum solution deriving section
514 Estimation result convergence determining section
520 Image restoring section
601 Inter-object region local PSF obtaining section
602 PSF positioning section
603 PSF filtering section

1. An object separating apparatus comprising:
a small region dividing section that divides an input image into a plurality of small region images;
a local PSF (Point Spread Function) estimating section that estimates PSFs of the small region images;
a PSF form identifying section that identifies forms of the estimated PSFs and groups the small region images such that small region images having the PSF forms with high similarity belong to the same group; and
a small region integrating section that obtains object images separated into respective groups by integrating, for each of the groups, the small region images that are grouped in the same group and are adjacent.

2. The object separating apparatus of claim 1, wherein the small region dividing section divides the input image such that the plurality of small region images overlap one another.

3. The object separating apparatus of claim 1, further comprising a PSF selecting section that selects whether to estimate the PSF of a small region image by using this small region image or by using the PSFs of surrounding small region images, based on a reliability of the PSF of this small region image.

4. The object separating apparatus of claim 1, further comprising a grouping selecting section that selects whether to perform the grouping of a small region image by using a PSF estimation result of this small region image or by using a grouping result of surrounding small region images, based on a reliability of the PSF of this small region image.

5. An image restoration apparatus comprising:
the object separating apparatus of claim 1;
an object PSF estimating section that estimates PSFs of the respective object images by using respective object images separated by the object separating apparatus; and
an image restoring section that obtains a restored image in which degradations in the object images are corrected, by using the PSFs estimated by the object PSF estimating section and the object images.

6. The image restoration apparatus of claim 5, wherein the object PSF estimating section estimates the PSFs according to a MAP (Maximum A Posteriori) method, and uses the PSFs that have already been estimated by the local PSF estimating section as initial values.

7. An image restoration apparatus comprising:
the object separating apparatus of claim 1; and an image restoring section that obtains a restored image in which degradations in the object images are corrected, by using the object images that have been separated by the object separating apparatus and the PSFs that have already been estimated by the local PSF estimating section.

8. A method comprising a step of:
dividing an input image into a plurality of small regions;
estimating a PSF of each small region;
identifying a form of the estimated PSF of each small region and grouping the small regions such that small regions having the PSF forms with high similarity belong to the same group; and
obtaining object images separated into respective groups by integrating, for each of the groups, adjacent small regions that are grouped in the same group.

9. The method of claim 8, further comprising a step of:
obtaining object images separated into respective groups by integrating, for each of the groups, adjacent small regions that are grouped in the same group; estimating a PSF of each object image by using respective separated object images; and
obtaining a restored image in which degradations in the object images are corrected by using the estimated PSFs of the object images and the object images.

10. The method of claim 8, further comprising a step of:
obtaining object images separated into respective groups by integrating, for each of the groups, adjacent small regions that are grouped in the same group; and obtaining a restored image in which degradations in the object images are corrected by using the object images and the estimated PSFs.
